(19) United States
(12) Patent Application Publication
(10) Pub. No.: US 2026/0278492 A1
(43) Pub. Date: Sep. 17, 2026

(54) SYSTEM AND METHOD FOR RIDE PLANNING, CONSTRUCTION, AND VALIDATION

(71) Applicant: Universal City Studios LLC, Universal City, CA (US)

(72) Inventor: Matthew Horton, Orlando, FL (US)

(21) Appl. No.: 19/566,532

(22) Filed: Mar. 13, 2026

Related U.S. Application Data
(60) Provisional application No. 63/772,290, filed on Mar. 14, 2025.

(51) Int. Cl. G06Q 10/0631

(52) U.S. Cl. CPC G06Q 10/06311

(57) ABSTRACT

A system for ride planning, construction, and/or validation includes a ride track configured to guide a ride vehicle, a first marker disposed on a first portion of the ride track, the first marker including a first characteristic, and a second marker disposed on a second portion of the ride track, the second marker including a second characteristic distinguishable from the first characteristic. The system also includes a scanner assembly. The scanner assembly is configured to determine, based on detecting the first characteristic, first metadata indicative of a first purpose of the first marker and first location information associated with the first marker. The scanner assembly is also configured to determine, based on detecting the second characteristic, second metadata indicative of a second purpose of the second marker and second location information associated with the second marker, where the second purpose is different than the first purpose, and the second location information is different than the first location information.

### CROSS-REFERENCE TO RELATED APPLICATIONS

This application claims priority to and the benefit of U.S. Provisional Application No. 63/772,290, entitled “SYSTEM AND METHOD FOR RIDE PLANNING, CONSTRUCTION, AND TRACKING,” filed Mar. 14, 2025, which is incorporated by reference herein in its entirety for all purposes.

### BACKGROUND

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

Entertainment venues, such as theme or amusement parks, have been created to provide guests with various immersive experiences. These entertainment venues may include various attractions, such as rides (e.g., rollercoasters), shows, games, and the like. Because entertainment venues may include a number of attractions in a tightly packed space, attraction planning, construction, validation, and operation can be complex. For example, considerable effort may be taken to ensure that an attraction does not interfere with another attraction, that various elements of an attraction are appropriately placed, etc. Traditional configurations, such as traditional dimensioning configurations, may be time consuming, unreliable, expensive, and/or effective for a finite period of time. Accordingly, it is now recognized that improved systems and methods are desired.

### BRIEF DESCRIPTION

Embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In an embodiment, a system for ride planning, construction, and/or validation includes a ride track configured to guide a ride vehicle, a first marker disposed on a first portion of the ride track, the first marker including a first characteristic, and a second marker disposed on a second portion of the ride track, the second marker including a second characteristic distinguishable from the first characteristic. The system also includes a scanner assembly. The scanner assembly is configured to determine, based on detecting the first characteristic, first metadata indicative of a first purpose of the first marker and first location information associated with the first marker. The scanner assembly is also configured to determine, based on detecting the second characteristic, second metadata indicative of a second purpose of the second marker and second location information associated with the second marker, where the second purpose is different than the first purpose, and the second location information is different than the first location information

In an embodiment, a method for planning, constructing, and/or validating a ride system includes disposing a first marker on a first portion of a ride track, the first marker including a first characteristic, and disposing a second marker on a second portion of the ride track, the second marker including a second characteristic distinguishable from the first characteristic. Then, the method includes installing the first portion of the ride track and the second portion of the ride track in the ride system.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of a process for ride planning, construction, and validation of a ride system, where the process employs building information modeling (BIM) and marker placement and scanning, thereby establishing a dimensioning reference system, in accordance with an aspect of the present disclosure;

FIG. 2 is a perspective view of a first portion of a ride track of a ride system, such as the ride system included in the process of FIG. 1, the first portion including a first marker (e.g., a first unique marker) thereon, in accordance with an aspect of the present disclosure;

FIG. 3 is a perspective view of a second portion of a ride track of a ride system, such as the ride system included in the process of FIG. 1, the second portion including a second marker (e.g., a second unique marker) thereon, and the second portion being configured to extend from or couple to the first portion in FIG. 2, in accordance with an aspect of the present disclosure;

FIG. 4 is a perspective view of a third portion of a ride track of a ride track of a ride system, such as the ride system included in the process of FIG. 1, the third portion including a third marker (e.g., a third unique marker) thereon, and the third portion being configured to extend from or couple to the second portion in FIG. 3, in accordance with an aspect of the present disclosure;

FIG. 5 is a perspective view of a fourth portion of a ride track of a ride system, such as the ride system included in the process of FIG. 1, the fourth portion including a fourth marker (e.g., a fourth unique marker) thereon, and the fourth portion being configured to extend from or couple to the third portion in FIG. 4, in accordance with an aspect of the present disclosure; and

FIG. 6 is a perspective view of a fifth portion of a ride track of a ride system, such as the ride system included in the process of FIG. 1, the fifth portion including a fifth marker (e.g., a fifth unique marker) thereon, and the fifth portion being configured to extend from or couple to the fourth portion in FIG. 5, in accordance with an aspect of the present disclosure; and

FIG. 7 is a process flow diagram illustrating a method for planning, constructing, and/or validating a ride system, such as the ride system included in the process of FIG. 1, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure relates generally to systems and methods for ride planning, construction, and validation. More specifically, the present disclosure relates to systems and methods in which a virtual model (e.g., via building information modeling or BIM), a scanner assembly, and/or a plurality of markers (e.g., distinguishable and/or categorizable markers) are employed to plan, develop, construct, and/or validate a ride system.

In accordance with embodiments of the present disclosure, multiple teams may coordinate during ride system planning, construction, and/or validation. For example, a first team may include a facilities team that handles aspects of the ride system pertaining to facilities, including (but not necessarily limited to) building architectural, structural, and mechanical systems (e.g., locations, sizes, etc. of facilities corresponding to or being located adjacent to the ride system). A second team may include a show set team that handles aspects of the ride system pertaining to show effects or elements (e.g., locations, sizes, functions, etc. of the show effects or elements corresponding to or being located adjacent to the ride system). A third team may include a robotics team that handles aspects of the ride system pertaining to robotics (e.g., locations, sizes, functions, etc. of the robotics corresponding to or being located adjacent to or on the ride system). Other teams, such as a fourth team, a fifth team, a sixth team, etc., are also possible in accordance with the present disclosure. It is presently recognized that, in traditional systems and methods, such as traditional dimensioning systems and methods, coordination between the various teams associated with the ride system may be cumbersome, incongruous, or otherwise difficult.

Further, each team described above may include a plurality of roles that may be coordinated during ride system planning, construction, and/or validation. For example, the show set team (e.g., the second team described above) may include a first role corresponding to show set figures and a second role corresponding to show set props. Likewise, the robotics team (e.g., the third team described above) may include a first role corresponding to robotic figures and a second role corresponding to robotic props. Other teams and/or other roles within specific teams are also possible in accordance with the present disclosure. It is presently recognized that, in traditional systems and methods, such as traditional dimensioning systems and methods, coordination between various roles within a specific team associated with the ride system may be cumbersome, incongruous, or otherwise difficult.

Systems and methods of the present disclosure are directed to ride planning, construction, and/or validation in a way that reduces, mitigates, or negates the above-described challenges, among others. For example, in some embodiments, various portions of the ride system, such as various portions of a ride track of the ride system, include markers thereon, each marker including one or more characteristics configured to denote one or more purposes of the marker. The purpose(s) may include (but are not limited to), for example, indicating or alerting a particular team associated with or otherwise pertaining to the portion of the ride track at issue, indicating a particular role within a particular team associated with or otherwise pertaining to the portion of the ride track at issue, indicating a sequence or chronology of the portion of the ride track at issue within the ride system generally, and/or other purposes.

As a non-limiting example, a first marker on a first portion of a ride track may include three characteristics, such as a first shape denoting a first team associated with or otherwise pertaining to the first portion of the ride track, one or more first letters denoting a role within the first team associated with or otherwise pertaining to the first portion of the ride track, and a first number denoting the sequence or chronology of the first portion of the ride track within the ride system generally. A second marker on a second portion of the ride track also may include three characteristics, such as a second shape denoting a second team associated with or otherwise pertaining to the second portion of the ride track, one or more second letters denoting a role within the second team associated with or otherwise pertaining to the second portion of the ride track, and a second number denoting the sequence or chronology of the second portion of the ride track within the ride system generally. It should be understood that, while each characteristic of the first marker may be distinguishable from (e.g., different than) each corresponding characteristic of the second marker, certain markers may include characteristics common with the first marker, the second marker, or both. For example, a third marker on a third portion of the ride track also may include three characteristics, such as the first shape denoting the first team (e.g., common with the first shape of the first marker), one or more third letters denoting a role within the first team, and a third number denoting the sequence or chronology of the third portion of the ride track. In this way, in certain embodiments of the present disclosure, each marker may include a plurality of characteristics that enables identification of the purpose(s) of the marker. It should be understood that other characteristics are also possible, for example, in addition to or in the alternate of the characteristics described above, such as a size of the marker or one or more portions thereof, a color of the marker or one or more portions thereof, etc. As described in greater detail with reference to the drawings, each marker may be engraved on the respective portion of the ride track, painted on the respective portion of the ride track, etched into the respective portion of the ride track, or the like. Additionally or alternatively, in some embodiments, the marker may include a quick response (QR) code, a barcode, a radio frequency identifier (RFID) tag, or the like.

In addition to the features outlined above, presently disclosed embodiments may include a virtual model of the ride system, where the virtual model is rendered at some point during ride planning, construction, and/or validation. As an example, the virtual model may be rendered during planning of the ride system and then employed during construction (e.g., to properly locate various portions of the ride system) and/or validation (e.g., to confirm proper locations of various portions of the ride system) of the ride system. In this way, the virtual model may correspond to or otherwise include a virtual ride system that serves as a reference during construction and/or validation of the ride system. In some embodiments, the virtual model includes virtual markers on virtual portions of the virtual ride system (e.g., virtual portions of a virtual ride track of the virtual ride system), where the virtual markers correspond to the markers of the ride system described above. Additionally or alternatively, the virtual model may include metadata indicating information related to each marker of the ride system. Such information captured in the metadata may indicate, for example, the purpose(s) of the marker(s) at issue, such as the purpose(s) described above (e.g., the team associated with the marker, the role within the team, the sequence or chronology of the portion of the ride system within the ride system generally, etc.).

As described in greater detail below, the metadata corresponding to each marker also may include information indicating a location, also referred to as a target or planned location, at which the portion of the ride track (or the marker disposed thereon) should be disposed. The information pertaining to the location may be, for example, in the form of coordinates of a coordinate system (e.g., in relation to an origin, in relation to an adjacent portion of the ride system or marker thereof, in the form of geo-coordinates, etc.) at which the portion of the ride system should be disposed, although other types of location-based information (e.g., enabling triangularization of one or more markers) are also possible. The information pertaining to the location may be, for example, stored in the virtual model where a virtual location of a virtual marker corresponds to an actual location of a marker of the ride system described above.

As previously described, the markers may be employed during ride construction and/or validation to coordinate work between teams, properly locate various portions of the ride track (or other portions of the ride system) within the ride system generally, and/or confirm (e.g., validate) that the various portions of the ride track (or markers disposed thereon) or other portions of the ride system are properly located. As an example, each marker may be identified (e.g., detected) to retrieve the metadata associated therewith and described above, and/or to properly locate the corresponding portion of the ride track (or marker disposed thereon) within the ride system generally via, for example, a scanner assembly. The scanner assembly, which may include a scanner, survey equipment, processing circuitry, memory circuitry, and/or other componentry, will be described in greater detail with reference to the drawings. As previously described, the metadata may include information indicating a location at which the marker should be disposed, a description of the purpose(s) (e.g., team, role within team, sequence or chronology) corresponding to the marker, or any combination thereof. Additionally or alternatively, the information indicating the location may correspond to a virtual location of a virtual marker in the virtual model. The information indicating the location at which the marker should be disposed, for example, may be cross-referenced with the actual location detected, for example, by the survey equipment of the scanner assembly. In this way, the marker and corresponding portion of the ride track (or other portion of the ride system) may be located and such location may be validated (e.g., confirmed) as proper. In some embodiments, for example, multiple markers employed in the ride system, such as two markers or three markers, may be placed to ensure that they are within a field of view (e.g., within a line-of-sight) of the surveying equipment, which may enable triangularization of a particular marker for proper location of the respective portion of the ride track.

In some embodiments, the virtual model described above may be updated during ride construction and/or validation in one or more ways. For example, upon validating proper locations of markers corresponding to various portions of the ride system (e.g., portions of the ride track), the virtual model may be updated with validation indicators. The validation indicators may include, for example, checkmarks corresponding to the validated markers, color-coding indicating validation (e.g., changing a marker from one color, such as yellow, to another color, such as green), and the like. The validation indicators may be visible on the rendering of the virtual ride system within the virtual model, in the metadata corresponding to each virtual marker, or both. Additionally or alternatively, the virtual model may be updated to change locations of virtual markers and/or to change location information within the metadata corresponding to the virtual markers. For example, as the ride system is being constructed, markers corresponding to various portions of the ride system (e.g., portions of the ride track) may be misplaced for one or more reasons, such as engineering tolerances or error margins, necessity, and/or other reasons. In certain circumstances, such misplacement of the markers corresponding to various portions of the ride system (e.g., portions of the ride track) may be permissible despite non-conformance with the virtual model generated during ride planning. In such circumstances, the virtual model may be updated, for example, by moving the virtual markers at issue and/or updating portions of the metadata indicative of the location information. Such updates to the virtual model may be based, for example, on feedback received from the scanning assembly indicative of the actual location(s) of the marker(s) at issue, manual entry, or any combination thereof.

In certain instances of the present disclosure above and below, the characteristics of the markers are described as indicating various purposes of the markers, such as identifying relevant teams, roles within the teams, sequence or chronology of the corresponding portions of the ride system (e.g., portions of the ride track), and the like, and the markers in general are described as enabling proper location of the corresponding portions of the ride system (e.g., portions of the ride track) within the ride system generally. In addition to these benefits, the markers may enable proper placement of other componentry, such as componentry that does not include the ride track, of the ride system, meant to interact with the ride system, of other ride systems or attractions in the entertainment venue, and the like. For example, at least some of the markers may serve as reference points for properly placing show set pieces, animated figures, other componentry, or any combination thereof along or adjacent to the ride track, for example, at one or more pre-defined distances from the marker(s) at issue. In some embodiments, such other componentry of the ride system also may be rendered in the virtual model. While certain of such componentry (e.g., show set pieces, animated figures, etc.) of the ride system may be unmarked, certain other of such componentry (e.g., show set pieces, animated figures, etc.) of the ride system also may include one of the markers. These and other aspects of the present disclosure are described in detail below with reference to the drawings.

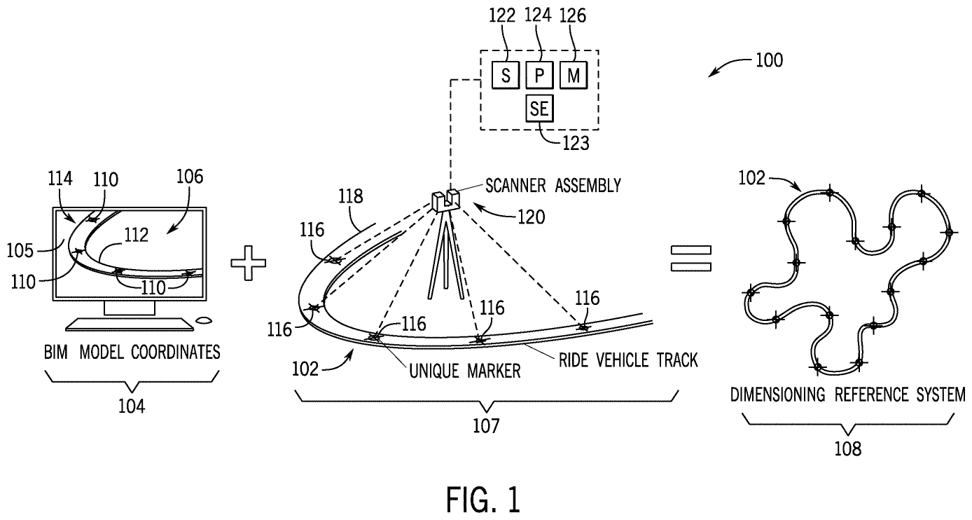

Continuing now to the drawings, FIG. 1 is a schematic illustration of an embodiment of a process 100 for ride planning, construction, and validation of a ride system 102, where the process 100 employs building information modeling (BIM) 104 to build a virtual model 106 of the ride system 102 (e.g., a virtual rendering of the ride system 102, metadata associated with the ride system 102, etc.), marker placement and scanning 107 on the ride system 102 itself, and a dimensioning reference system 108 (e.g., between the virtual model 106 and the ride system 102). As shown, the virtual model 106 may be output to a device display 105 via, for example, a graphical user interface (GUI) in certain embodiments of the present disclosure. In certain embodiments of the present disclosure, the virtual model 106 of the ride system 102 may include virtual markers 110 disposed on a virtual ride track 112 of a virtual ride system 114 corresponding to the ride system 102. Likewise, the ride system 102 itself may include markers 116 corresponding to the virtual markers 110 and disposed on a ride track 118 corresponding to the virtual ride track 112. That is, each marker 116 on the ride track 118 of the ride system 102 may include a corresponding virtual marker 110 on the virtual ride track 112 of the virtual ride system 114. As described in detail below, the virtual model 106 may be generated via the BIM 104 prior to construction and installation of the ride system 102 in the entertainment venue, which simplifies planning, construction, and/or monitoring.

For example, as previously described, multiple teams may coordinate during the process 100 of ride system planning and/or construction. For example, a first team may include a facilities team that handles aspects of the ride system 102 pertaining to facilities, including (but not necessarily limited to) building architectural, structural, and mechanical systems (e.g., locations, sizes, etc. of facilities corresponding to or being located adjacent to the ride system). A second team may include a show set team that handles aspects of the ride system 102 pertaining to show effects or elements (e.g., locations, sizes, functions, etc. of the show effects or elements corresponding to or being located adjacent to the ride system). A third team may include a robotics team that handles aspects of the ride system 102 pertaining to robotics (e.g., locations, sizes, functions, etc. of the robotics corresponding to or being located adjacent to or on the ride system). Other teams, such as a fourth team, a fifth team, a sixth team, etc. are also possible in accordance with the present disclosure. It is presently recognized that, in traditional systems and methods (e.g., traditional dimensioning systems and methods), coordination between the various teams associated with the ride system 102 may be cumbersome, incongruous, or otherwise difficult.

Further, each team described above may include a plurality of roles that may be coordinated during ride system planning, construction, and/or validation. For example, the show set team (e.g., the second team described above) may include a first role corresponding to show set figures and a second role corresponding to show set props. Likewise, the robotics team (e.g., the third team described above) may include a first role corresponding to robotic figures and a second role corresponding to robotic props. Other teams and/or other roles within specific teams are also possible in accordance with the present disclosure. It is presently recognized that, in traditional systems and methods, such as traditional dimensioning systems and methods, coordination between various roles within a specific team associated with the ride system 102 may be cumbersome, incongruous, or otherwise difficult.

In the illustrated process 100, each virtual marker 110 and/or each marker 116 may include various characteristics configured to indicate various purposes thereof. For example, one characteristic may indicate the team assigned to, associated with, or otherwise pertaining to the virtual marker 110 and/or the marker 116 corresponding thereto, another characteristic may indicative the role within the team, and another characteristic may indicate, for example, a sequence or chronology of the respective portion of the virtual ride track 112 and/or the respective portion of the ride track 118. That is, each team may be assigned a certain type of unique marker characteristic (e.g., a shape) that may be employed to plan, construct, and/or validate aspects of the ride system pertaining to each team, each role may be assigned a certain type of unique marker characteristic (e.g., one or more letters), and each sequence or chronology may be assigned a certain type of unique marker characteristic (e.g., a number). As an example, the facilities team may be assigned a circle, the show set team may be assigned a diamond, and the robotics team may be assigned a triangle. However, it should be understood that the characteristic types may be assigned differently. For example, one or more letter(s) may be employed to identify the sequence or chronology of the portion of the ride track 118 in the ride system 102 generally, numbers may be employed to identify the team associated with the portion of the ride track 118, and shapes may be employed to identify the role within the team. Further still, other characteristics indicating other purposes of the virtual marker 110 and/or the marker 116 are also possible, such as sizes of the virtual marker 110 and/or the marker 116, colors of the virtual marker 110 and/or the marker 116, etc. Such unique markers and characteristics thereof first may be virtually rendered on an aspect (e.g., the virtual ride track 112) of the virtual model 106 (e.g., via the virtual markers 110) and then physically rendered on an aspect (e.g., the ride track 118) of the actual ride system 102. The markers 116 may be disposed on portions of the ride track 118 by way of engravings, etchings, paintings, quick response (QR) codes, barcodes, radio frequency identifier (RFID) tags, and the like.

Further, the markers 116 may be employed to properly locate the portions of the ride track 118 or other portions of the ride system 102 generally. For example, as outlined in greater detail below, the virtual model 106 may include metadata associated with each virtual marker 110, where the metadata indicates, for example, the various purpose(s) outlined in detail above along with information indicative of a location of each virtual marker 110, which may correspond to a target or desired location of the marker 116 corresponding to the virtual marker 110. In some embodiments, the target or desired location may include coordinates (e.g., x, y, and z coordinates) corresponding to a coordinate system, for example, with a pre-defined origin. Additionally or alternatively, the target or desired location of a particular one of the markers 116 may be stored in the form of coordinates in relation to (and/or one or more distances from) an adjacent one of the markers 116. While marker characteristics are employed to denote marker purposes as outlined above, in some embodiments, such marker characteristics do not necessarily denote marker location information. Instead, the location information may coincide with the virtual location of the virtual markers 110 in the virtual model 106. Additionally or alternatively, the retrievable metadata stored in the virtual model 106 and associated with the virtual marker 110 and the marker 116 corresponding thereto may indicate the location of the virtual marker 110 and, in turn, the target or desired location of the marker 116.

During and/or after construction of the ride system 102, a scanner assembly 120 may be employed to detect the markers 116 and/or ensure that componentry of the ride system 102 is properly located based at least in part on the markers 116 distributed about the ride track 118 (and, in some embodiments, other componentry) of the ride system 102. The scanner assembly 120 may include, for example, at least one scanner 122, processing circuitry 124 (e.g., one or more processors), and memory circuitry 126 (e.g., one or more memories) storing instructions thereon that, when executed by the processing circuitry 124, cause the processing circuitry 124 to perform various functions. In some embodiments, the scanner assembly 120 also includes surveying equipment 123 separate from the scanner 122, while in other embodiments, the scanner 122 itself includes the surveying equipment 123. For example, the scanner 122 and/or the surveying equipment 123 may include Light Detection and Ranging (LiDAR) equipment, a light source, photosensitive sensors, a radio frequency identifier (RFID) detector, a camera, a quick response (QR) code reader, a barcode reader, or any combination thereof, configured to detect the markers 116 and/or characteristics thereof.

The processing circuitry 124 may include a general purpose or specific purpose processor, an application specific integrated circuit (ASIC), one or more field programmable gate arrays (FPGAs), a group of processing components, or other suitable processing components. In general, the processing circuitry 124 is configured to execute computer code or instructions stored in the memory circuitry 126 or received from other computer readable media (e.g., CDROM, network storage, a remote server, etc.). The memory circuitry 126 may include one or more devices (e.g., memory units, memory devices, storage devices, etc.) for storing data and/or computer code for completing and/or facilitating the various processes described in the present disclosure. Further, the memory circuitry 126 may include random access memory (RAM), read-only memory (ROM), hard drive storage, temporary storage, non-volatile memory, flash memory, optical memory, or any other suitable memory for storing software objects and/or computer instructions. Further still, the memory circuitry 126 may include database components, object code components, script components, or any other type of information structure for supporting the various activities and information structures described in the present disclosure. In certain embodiments of the present disclosure, the processing circuitry 124 and the memory circuitry 126 may be collectively referred to as a controller or form a part of one or more controllers.

In certain embodiments of the present disclosure, the processing circuitry 124 may execute the instructions stored on the memory circuitry 126, for example, to receive feedback from the scanner 122 and/or the surveying equipment 123 to determine, based on the feedback, identifying information corresponding to the marker 116 at issue, as described in greater detail below with reference to later drawings. For example, the processing circuitry 124 may identify the marker 116 and retrieve the metadata associated with the marker 116, such as the purpose(s) of the marker 116, and/or the target or desired location of the marker 116, for example, based on feedback from the scanner 122 and/or the surveying equipment 123. In some embodiments, the processing circuitry 124 and/or the memory circuitry 126 is integrated with the scanner 122 and/or the surveying equipment 123, while in other embodiments, the processing circuitry 124 and/or the memory circuitry 126 is separate from and communicatively coupled to (e.g., via a wired or wireless connection) the scanner 122 and/or the surveying equipment 123.

In some embodiments, as shown in the marker placement and scanning 107 steps of FIG. 1, multiple markers 116 are disposed within a field of view (e.g., a single field of view, or line-of-sight) of the scanner assembly 120 (e.g., the scanner 122 and/or the surveying equipment 123), which improves proper placement of componentry of the ride system 102. For example, the multiple markers 116 being within the field of view (e.g., a single field of view, or line-of-sight) of the scanner assembly 120 (e.g., the scanner 122 and/or the surveying equipment 123) may enable triangularization for proper location of at least one of the markers 116. In this way, the process 100 ensures that the marker 116 and corresponding componentry (e.g., ride track 118, etc.) of the ride system 102 is properly placed, that facilities, show element, and robotics associated with the ride system 102 are properly implemented and coordinated (e.g., with respect to the related markers 116), and the like. By way of the BIM 104 and marker placement and scanning 107 steps of the process 100 illustrated in FIG. 1 and described above, a dimensioning reference system 108 is achieved as shown.

In some embodiments, the virtual model 106 described above may be updated during ride construction and/or validation in one or more ways. For example, upon validating proper locations of the markers 116 corresponding to various portions of the ride system 102 (e.g., portions of the ride track 118), the virtual model 106 may be updated with validation indicators. The validation indicators may include, for example, checkmarks corresponding to the markers 116 that have been validated with respect to the virtual markers 110, color-coding indicating validation (e.g., changing one of the virtual markers 110 from one color, such as yellow, to another color, such as green), and the like. The validation indicators may be visible on the rendering of the virtual ride system 114 within the virtual model 106, in the metadata corresponding to each virtual marker 110, or both. Additionally or alternatively, the virtual model 106 may be updated to change locations of virtual markers 110 and/or to change location information within the metadata corresponding to the virtual markers 110. For example, as the ride system 102 is being constructed, markers 116 corresponding to various portions of the ride system 102 (e.g., portions of the ride track 118) may be misplaced for one or more reasons, such as engineering tolerances or error margins, necessity, and/or other reasons. In certain circumstances, such misplacement of the markers 116 corresponding to various portions of the ride system 102 (e.g., portions of the ride track 118) may be permissible despite non-conformance with the virtual model 106 generated during ride planning. In such circumstances, the virtual model 106 may be updated, for example, by moving the virtual markers 110 at issue and/or updating portions of the metadata indicative of the location information. Such updates to the virtual model 106 may be based, for example, on feedback received from the scanning assembly 120 indicative of the actual location(s) of the marker(s) 116 at issue, manual entry, or any combination thereof.

In certain instances of the present disclosure above and below, the characteristics of the markers 116 are described as indicating various purposes of the markers 116, such as identifying relevant teams, roles within the teams, sequence or chronology of the corresponding portions of the ride system 102 (e.g., portions of the ride track 118), and the like, and the markers 116 in general are described as enabling proper location of the corresponding portions of the ride system 102 (e.g., portions of the ride track 118) within the ride system generally. In addition to these benefits, the markers 116 may enable proper placement of other componentry, such as componentry that does not include the ride track 118, of the ride system 102, meant to interact with the ride system 102, of other ride systems or attractions in the entertainment venue, and the like. For example, at least some of the markers 116 may serve as reference points for properly placing show set pieces, animated figures, other componentry, or any combination thereof along or adjacent to the ride track 118, for example, at one or more pre-defined distances from the marker(s) 116 at issue. In some embodiments, such other componentry of the ride system 102 also may be rendered in the virtual model 106. While certain of such componentry (e.g., show set pieces, animated figures, etc.) of the ride system 102 may be unmarked, certain other of such componentry (e.g., show set pieces, animated figures, etc.) of the ride system 102 also may include one of the markers.

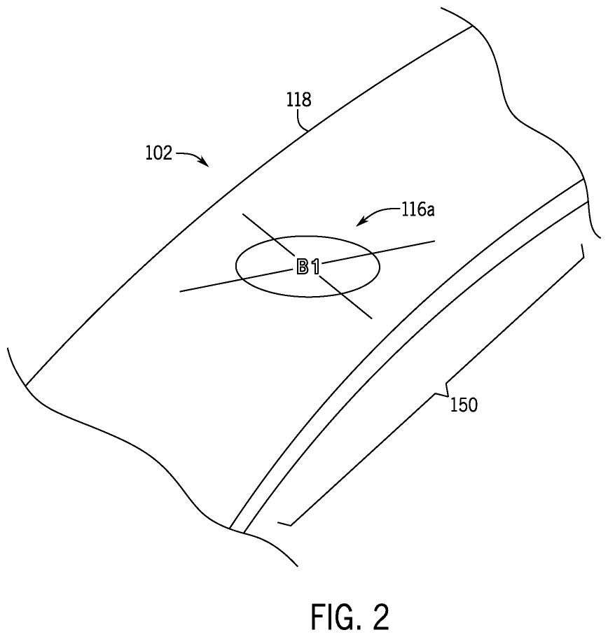

As previously described, each marker 116 of the ride system 102 (and virtual marker 110 of the virtual ride system 114 of the virtual model 106) includes at least one distinguishable characteristic that can be identified (e.g., via the scanner assembly 120) during planning and/or construction of the ride system 102. FIGS. 2-6 illustrate various example markers 116 with such distinguishing characteristic(s). In the description below, letters of the example markers 116 are characterized as indicating a purpose or role corresponding to the example markers 116, numbers of the example markers 116 are characterized as indicating a chronology or sequence of such markers 116 within the respective team, and shapes around the letters and numbers are characterized as indicating a team for whom the markers 116 are intended. However, it should be understood that the meanings of the letters, numbers, and shapes may be different in other embodiments (e.g., the numbers may indicate the team, the letters may indicate the chronology or sequence, etc.). Further, other types of characteristics are also possible. Further still, while the markers 116 described below may be embedded in aspects (e.g., the ride track 118) of the ride system 102 via etching, for example, other types of markers (e.g., RFID tags, painting, an attachment point for a detachable 3D target, barcodes, QR codes, etc.) are also possible in accordance with the present disclosure. The markers 116 may be disposed on the ride track 118 either before or after the ride track 118 is installed in the ride system 102.

FIG. 2 is a perspective view of an embodiment of a first portion 150 of the ride track 118 of the ride system 102 in the process 100 of FIG. 1, the first portion 150 including a first marker 116a (e.g., a first unique marker) thereon. As shown in the illustrated embodiment, the first marker 116a includes at least three characteristics, such as the letter “B,” the number “1,” and the shape of a circle, where each characteristic is configured to denote a purpose of the first marker 116a. As an example, the shape may indicate a team interested in, associated with, or otherwise pertaining to the first marker 116a, the letter(s) may indicate a role within the team, and the number may indicate a sequence or chronology of the first portion 150 of the ride track 118 within the ride system 102. It should be understood that the letter, the number, and the shape may not be matched to the specific purposes described above in other embodiments. For example, in another embodiment, the number may indicate the team, the shape may indicate the role within the team, and the letter(s) may indicate the sequence or chronology of the first portion 150 of the ride track 118 within the ride system 102. Additional or alternate characteristics of the first marker 116a, such as a size and/or a color of the first marker 116a, denoting additional or alternate purposes of the first marker 116a are also possible in accordance with the present disclosure. Further, it should be noted that the scanner assembly 120 in FIG. 1 may be capable of detecting the letter, the number, and the shape, and retrieving, based on such detection of the first marker 116a and/or characteristics thereof, the metadata associated with the first marker 116a as previously described. The metadata may be employed, for example, to identify the purpose(s) of the first marker 116a and/or the desired or target location of the first marker 116a.

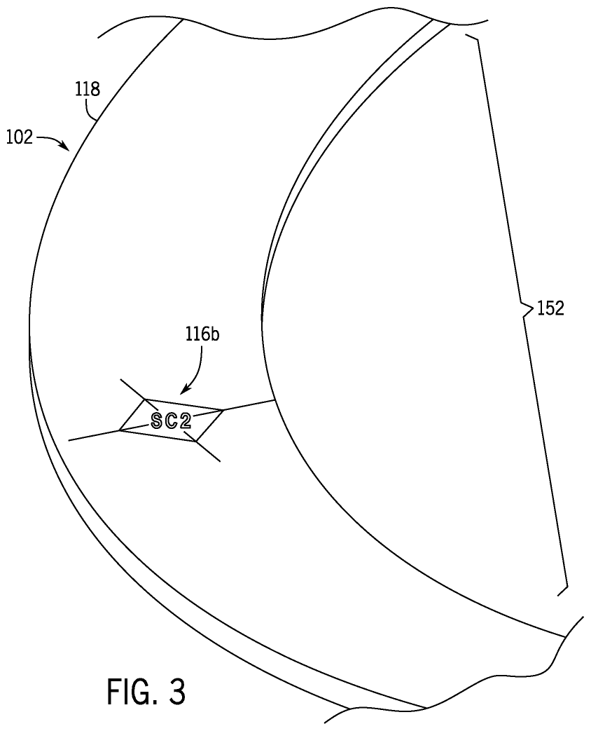

FIG. 3 is a perspective view of an embodiment of a second portion 152 of the ride track 118 of the ride system 102 in the process 100 of FIG. 1, the second portion 152 including a second marker 116b (e.g., a second unique marker) thereon, and the second portion 152 being configured to extend from or couple to the first portion 150 in FIG. 2. As shown in the illustrated embodiment, the second marker 116b includes at least three characteristics, such as the letters “SC,” the number “2,” and the shape of a diamond, where each characteristic is configured to denote a purpose of the second marker 116b. As an example, the shape may indicate a team interested in, associated with, or otherwise pertaining to the second marker 116b, the letter(s) may indicate a role within the team, and the number may indicate a sequence or chronology of the second portion 152 of the ride track 118 within the ride system 102. It should be understood that the letters, the number, and the shape may not be matched to the specific purposes described above in other embodiments. For example, in another embodiment, the number may indicate the team, the shape may indicate the role within the team, and the letter(s) may indicate the sequence or chronology of the second portion 152 of the ride track 118 within the ride system 102. Additional or alternate characteristics of the second marker 116b, such as a size and/or a color of the second marker 116b, denoting additional or alternate purposes of the second marker 116b are also possible in accordance with the present disclosure. Further, it should be noted that the scanner assembly 120 in FIG. 1 may be capable of detecting the letter, the number, and the shape, and retrieving, based on such detection of the second marker 116b and/or characteristics thereof, the metadata associated with the second marker 116b as previously described. The metadata may be employed, for example, to identify the purpose(s) of the second marker 116b and/or the desired or target location of the second marker 116b.

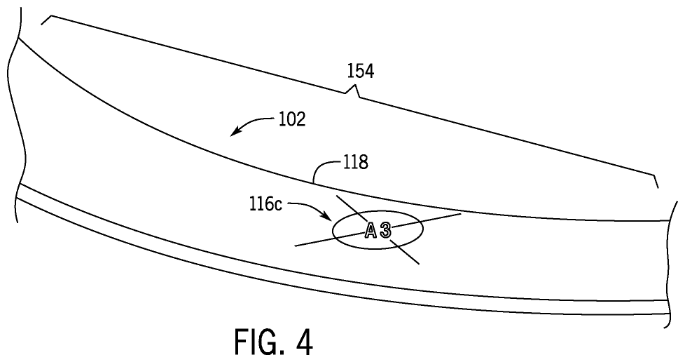

FIG. 4 is a perspective view of an embodiment of a third portion 154 of the ride track 118 of the ride system 102 in the process 100 of FIG. 1, the third portion 154 including a third marker 116c (e.g., a third unique marker) thereon, and the third portion 154 being configured to extend from or couple to the second portion 152 in FIG. 3. As shown in the illustrated embodiment, the third marker 116c includes at least three characteristics, such as the letter “A,” the number “3,” and the shape of a circle, where each characteristic is configured to denote a purpose of the third marker 116c. As an example, the shape may indicate a team interested in, associated with, or otherwise pertaining to the third marker 116c (e.g., the first team discussed above with respect to the first marker 115a in FIG. 2, which also includes a circle), the letter(s) may indicate a role within the team, and the number may indicate a sequence or chronology of the third portion 154 of the ride track 118 within the ride system 102. It should be understood that the letters, the number, and the shape may not be matched to the specific purposes described above in other embodiments. For example, in another embodiment, the number may indicate the team, the shape may indicate the role within the team, and the letter(s) may indicate the sequence or chronology of the third portion 154 of the ride track 118 within the ride system 102. Additional or alternate characteristics of the third marker 116c, such as a size and/or a color of the third marker 116c, denoting additional or alternate purposes of the third marker 116c are also possible in accordance with the present disclosure. Further, it should be noted that the scanner assembly 120 in FIG. 1 may be capable of detecting the letter, the number, and the shape, and retrieving, based on such detection of the third marker 116c and/or characteristics thereof, the metadata associated with the third marker 116c as previously described. The metadata may be employed, for example, to identify the purpose(s) of the third marker 116c and/or the desired or target location of the third marker 116c.

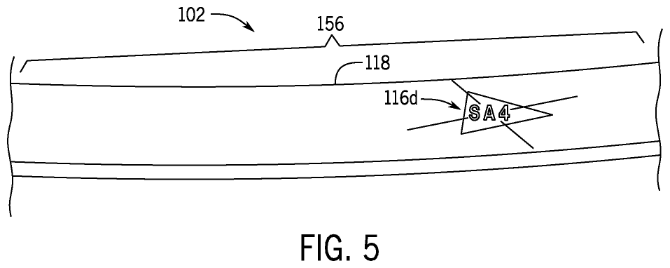

FIG. 5 is a perspective view of an embodiment of a fourth portion 156 of the ride track 118 of the ride system 102 in the process 100 of FIG. 1, the fourth portion 156 including a fourth marker 116d (e.g., a fourth unique marker) thereon, and the fourth portion 156 being configured to extend from or couple to the third portion 154 in FIG. 4. As shown in the illustrated embodiment, the fourth marker 116d includes at least three characteristics, such as the letters “SA,” the number “4,” and the shape of a triangle, where each characteristic is configured to denote a purpose of the fourth marker 116d. As an example, the shape may indicate a team interested in, associated with, or otherwise pertaining to the fourth marker 116d, the letter(s) may indicate a role within the team, and the number may indicate a sequence or chronology of the fourth portion 156 of the ride track 118 within the ride system 102. It should be understood that the letters, the number, and the shape may not be matched to the specific purposes described above in other embodiments. For example, in another embodiment, the number may indicate the team, the shape may indicate the role within the team, and the letter(s) may indicate the sequence or chronology of the fourth portion 156 of the ride track 118 within the ride system 102. Additional or alternate characteristics of the fourth marker 116d, such as a size and/or a color of the fourth marker 116d, denoting additional or alternate purposes of the fourth marker 116d are also possible in accordance with the present disclosure. Further, it should be noted that the scanner assembly 120 in FIG. 1 may be capable of detecting the letter, the number, and the shape, and retrieving, based on such detection of the fourth marker 116d and/or characteristics thereof, the metadata associated with the fourth marker 116d as previously described. The metadata may be employed, for example, to identify the purpose(s) of the fourth marker 116d and/or the desired or target location of the fourth marker 116d.

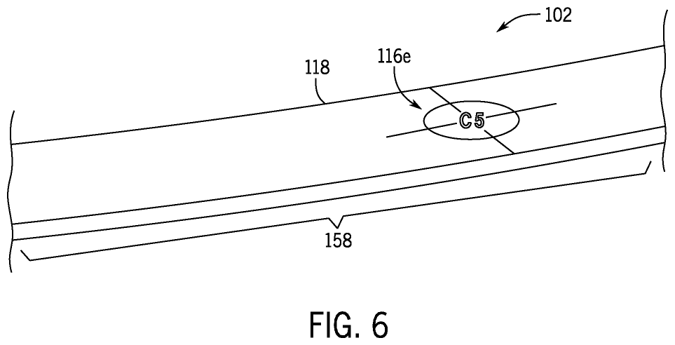

FIG. 6 is a perspective view of an embodiment of a fifth portion 158 of the ride track 118 of the ride system 102 in the process 100 of FIG. 1, the fifth portion 158 including a fifth marker 116e (e.g., a fifth unique marker) thereon, and the fifth portion 158 being configured to extend from or couple to the fourth portion 156 in FIG. 2. As shown in the illustrated embodiment, the fifth marker 116e includes at least three characteristics, such as the letter “C,” the number “5,” and the shape of a circle, where each characteristic is configured to denote a purpose of the fifth marker 116e. As an example, the shape may indicate a team interested in, associated with, or otherwise pertaining to the fifth marker 116e (e.g., the first team discussed above with respect to the first marker 116a in FIG. 2 and the third marker 116c in FIG. 4, which also include a circle), the letter(s) may indicate a role within the team, and the number may indicate a sequence or chronology of the fifth portion 158 of the ride track 118 within the ride system 102. It should be understood that the letter, the number, and the shape may not be matched to the specific purposes described above in other embodiments. For example, in another embodiment, the number may indicate the team, the shape may indicate the role within the team, and the letter(s) may indicate the sequence or chronology of the fifth portion 158 of the ride track 118 within the ride system 102. Additional or alternate characteristics of the fifth marker 116e, such as a size and/or a color of the fifth marker 116e, denoting additional or alternate purposes of the fifth marker 116e are also possible in accordance with the present disclosure. Further, it should be noted that the scanner assembly 120 in FIG. 1 may be capable of detecting the letter, the number, and the shape, and retrieving, based on such detection of the fifth marker 116e and/or characteristics thereof, the metadata associated with the fifth marker 116e as previously described. The metadata may be employed, for example, to identify the purpose(s) of the fifth marker 116e and/or the desired or target location of the fifth marker 116e.

The description of FIGS. 2-6 above includes the numbers “1,” “2,” “3,” “4,” and “5” for the first portion 150 of the ride track 118, the second portion 152 of the ride track 118 extending from (or coupled to) the first portion 150 of the ride track 118, the third portion 154 of the ride track 118 extending from (or coupled to) the second portion 152 of the ride track 118, the fourth portion 156 of the ride track 118 extending from (or coupled to) the third portion 154 of the ride track 118, and the fifth portion 158 of the ride track 118 extending from (or coupled to) the fourth portion 156 of the ride track 118, respectively. In other words, the sequence or chronology described in certain aspects of FIGS. 2-6 above may relate to the ride system 102 as a whole without duplicative numbers. However, it should be understood that the description above does not mean that numbering indicating sequences or chronologies cannot be duplicative across multiple markers, for example, so long as other characteristics of such multiple markers are different. As a non-limiting example, a first marker may include a first shape (e.g., a circle) assigned to a first team, a second marker may include a second shape (e.g., a square) assigned to a second team, and both the first marker and the second marker may include a common number (e.g., “1”). Although the first and second marker include the same number, the “1” of the first marker may be included to denote a sequence or chronology of the first marker applicable to work done by the first team, while the “1” of the second marker may be included to denote a sequence or chronology of the second marker applicable to work done by the second team. Further, for at least the reasons set forth above, among others, certain embodiments of the present may include numbers that appear to be out of order along the ride track of the ride system, as they may be meant to denote, for example, multiple distinct sequences or chronologies applicable to various teams involved in the ride planning, construction, and/or validation process.

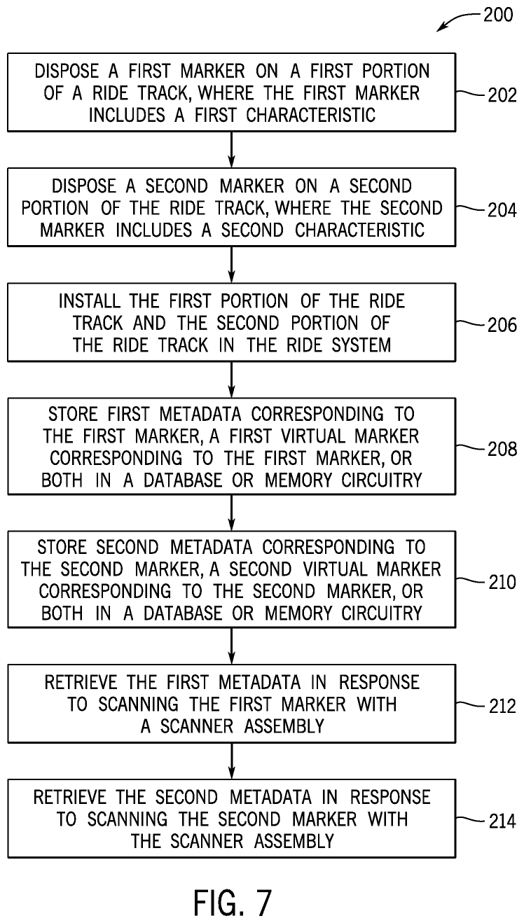

FIG. 7 is a process flow diagram illustrating an embodiment of a method 200 for planning, constructing, and/or validating a ride system, such as the ride system 102 included in the process 100 of FIG. 1 and/or portions of the ride system 102 illustrated in FIGS. 2-6. The method 200 may be performed in whole or in part, for example, by the scanner assembly 120 and/or the scanner 122, the processing circuitry 124, and the memory circuitry 126 thereof illustrated in FIG. 1. It should be noted that, while the steps of the method 200 may be performed in a chronology corresponding to the order of the steps illustrated in FIG. 7, in certain embodiments, the steps of the method 200 illustrated in FIG. 7 may be performed in a different chronology. Further, while certain embodiments of the method 200 include all the steps illustrated in FIG. 7, certain other embodiments of the method 200 may include only some of the steps illustrated in FIG. 7. Further still, while certain embodiments of the method 200 include only the steps illustrated in FIG. 7, certain other embodiments of the method 200 include additional steps not illustrated in FIG. 7.

In the illustrated embodiment, the method 200 may include disposing (block 202) a first marker on a first portion of a ride track, where the first marker includes a first characteristic. The method 200 also may include disposing (block 204) a second marker on a second portion of the ride track, where the second marker includes a second characteristic distinguishable from the first characteristic. The method 200 also may include installing (block 206) the first portion of the ride track and the second portion of the ride track in the ride system. For example, in certain embodiments, the second portion of the ride track may be coupled with the first portion of the ride track to install the second portion of the ride track in the ride system. It should be noted that, in some embodiments, block 206 may occur after block 202 and block 204.

The method 200 also may include storing (block 208) first metadata corresponding to the first marker, a first virtual marker corresponding to the first marker, or both in a database or memory circuitry, and storing (block 210) second metadata corresponding to the second marker, a second virtual marker corresponding to the second marker, or both in the database or memory circuitry. The method 200 also may include retrieving (block 212) the first metadata in response to scanning the first marker with a scanner assembly, and retrieving (block 214) the second metadata in response to scanning the second marker with the scanner assembly.

As previously described, the first metadata may be indicative of a first purpose and/or a first location (e.g., first coordinates) of the first marker, the first virtual marker, or both, among other possible information. Additionally or alternatively, the second metadata may be indicative of a second purpose and/or a second location (e.g., second coordinates) of the second marker the second virtual marker, or both, among other possible information. In this way, certain embodiments of the method 200 may include leveraging the first and second metadata to validate a first physical location of the first portion of the ride track of the ride system by comparing it with a first virtual location of a first virtual portion of a virtual model of the ride system, and to validate a second physical location of the second portion of the ride track of the ride system by comparing it with a second virtual location of a second virtual portion of the virtual model of the ride system. The first metadata, the second metadata, or both also may be employed to construct the ride system, for example, by identifying sequential portions of the ride track of the ride system to install in the ride system. Additionally or alternatively, the first metadata, the second metadata, or both may be employed to coordinate work on the ride system between multiple teams involved in the project, as previously described. It should be noted that other uses of the first metadata, the second metadata, or both in the planning, design, construction, validation, and/or maintenance of a ride system are also encompassed by embodiments of the present disclosure.

Presently disclosed embodiments simplify ride planning, design, construction, validation, and maintenance relative to traditional configurations, such as traditional dimensioning configurations. Further, presently disclosed embodiments improve the efficiency and/or accuracy of references between virtual models of ride systems and physical constructions of ride systems over traditional configurations, such as traditional dimensioning configurations, among other technical benefits.

While only certain features have been illustrated and described herein, many modifications and changes will occur to those skilled in the art. It is, therefore, to be understood that the appended claims are intended to cover all such modifications and changes as fall within the true spirit of the present disclosure.

The techniques presented and claimed herein are referenced and applied to material objects, concrete examples, and functional prototypes of a practical nature that demonstrably improve the present technical field and, as such, are not abstract, intangible or purely theoretical. Further, if any claims appended to the end of this specification contain one or more elements designated as “means for [perform]ing [a function]...” or “step for [perform]ing [a function]...”, it is intended that such elements are to be interpreted under 35 U.S.C. 112(f). However, for any claims containing elements designated in any other manner, it is intended that such elements are not to be interpreted under 35 U.S.C. 112(f).

1. A system for ride planning, construction, and/or validation, the system comprising:
a ride track configured to guide a ride vehicle;
a first marker disposed on a first portion of the ride track, wherein the first marker comprises a first characteristic;
a second marker disposed on a second portion of the ride track, wherein the second marker comprises a second characteristic distinguishable from the first characteristic; and
a scanner assembly configured to:
determine, based on detecting the first characteristic, first metadata indicative of a first purpose of the first marker and first location information associated with the first marker; and
determine, based on detecting the second characteristic, second metadata indicative of a second purpose of the second marker and second location information associated with the second marker, wherein the second purpose is different than the first purpose, and the second location information is different than the first location information.

2. The system of claim 1, wherein the first characteristic comprises a first shape and the second characteristic comprises a second shape distinguishable from the first shape.

3. The system of claim 1, wherein the first characteristic comprises a first size and the second characteristic comprises a second size distinguishable from the first size.

4. The system of claim 1, wherein the first characteristic comprises a first letter, a first number, or both, and the second characteristic comprises a second letter distinguishable from the first letter, a second number distinguishable from the first number, or both.

5. The system of claim 1, wherein the first marker comprises a first etching in the first portion of the ride track and the second marker comprises a second etching in the second portion of the ride track.

6. The system of claim 1, wherein the first marker comprises a first attachment point for a first detachable three-dimensional (3D) target in the first portion of the ride track, and the second marker comprises a second attachment point for a second detachable three-dimensional (3D) target in the second portion of the ride track.

7. The system of claim 1, wherein the first purpose corresponds to indicating a facilities planning and/or facilities construction team, a show set planning and/or show set construction team, or a robotics planning and/or robotics construction team.

8. The system of claim 1, comprising a third marker disposed on a third portion of the ride track, wherein the third marker comprises a third characteristic common with the first characteristic or the second characteristic.

9. The system of claim 1, comprising a third marker disposed on a third portion of the ride track, wherein the third marker comprises a third characteristic distinguishable from the first characteristic and the second characteristic, and wherein the scanner assembly is configured to determine, based on detecting the third characteristic, third metadata indicative of a third purpose of the third marker and third location information associated with the third marker, wherein the third purpose is different than the first purpose and the second purpose, and the third location information is different than the first location information and the second location information.

10. The system of claim 1, comprising a third marker disposed on a third portion of the ride track, wherein the first marker, the second marker, and the third marker are configured to be disposed in a field of view or line-of-sight of the scanner assembly.

11. The system of claim 1, wherein:
the first location information includes coordinates corresponding to a first target or desired location of the first marker; and
the second location information includes coordinates corresponding to a second target or desired location of the second marker.

12. The system of claim 1, comprising a database or memory circuitry configured to store the first metadata associated with the first marker and the second metadata associated with the second marker thereon.

13. The system of claim 12, wherein the database or memory circuitry is configured to store thereon a virtual rendering of a ride system, and the virtual rendering includes:
a virtual ride track corresponding to the ride track;
a first virtual portion of the virtual ride track corresponding to the first portion of the ride track;
a second virtual portion of the virtual ride track corresponding to the second portion of the ride track;
a first virtual marker corresponding to the first marker and disposed on the first virtual portion of the virtual ride track; and
a second virtual marker corresponding to the second marker and disposed on the second virtual portion of the virtual ride track.

14. The system of claim 13, comprising processing circuitry configured to validate, based on feedback from a scanner of the scanner assembly, survey equipment of the scanner assembly, or both:
that a first location of the first portion of the ride track, when installed, corresponds to the first location information; and
that a second location of the second portion of the ride track, when installed, corresponds to the second location information.

15. The system of claim 1, wherein the first portion of the ride track is discrete from the second portion of the ride track.

16. The system of claim 1, wherein the first portion of the ride track is coupled to the second portion of the ride track.

17. A method for planning, constructing, and/or validating a ride system, the method comprising:
disposing a first marker on a first portion of a ride track, wherein the first marker comprises a first characteristic;
disposing a second marker on a second portion of the ride track, wherein the second marker comprises a second characteristic distinguishable from the first characteristic; and then
installing the first portion of the ride track and the second portion of the ride track in the ride system.

18. The method of claim 17, comprising:
storing first metadata corresponding to the first marker, a first virtual marker corresponding to the first marker, or both in a database or memory circuitry; and
storing second metadata corresponding to the second marker, a second virtual marker corresponding to the second marker, or both in the database or memory circuitry.

19. The method of claim 18, comprising:
retrieving the first metadata in response to scanning the first marker with a scanner assembly; and
retrieving the second metadata in response to scanning the second marker with the scanner assembly.

20. The method of claim 18, wherein:
the first metadata comprises information indicative of a first purpose, a first location, or both of the first marker, the first virtual marker, or both; and
the second metadata comprises information indicative of a second purpose, a second location, or both of the first marker, the first virtual marker, or both.
